(19) United States
(12) Patent Application Publication
(10) Pub. No.: US 2019/0242168 A1
(43) Pub. Date: Aug. 8, 2019

(54) SLIDE DEVICE

(71) Applicant: MYPRO RESEARCH S.R.L., Thiene (VI) (IT)

(72) Inventor: Giancarlo BRUN, Thiene (VI) (IT)

(21) Appl. No.: 16/329,818

(22) PCT Filed: Aug. 4, 2017
(86) PCT No.: PCT/IB2017/054783

§ 371 Date: Mar. 1, 2019

(30) Foreign Application Priority Data
Sep. 1, 2016 (IT) 102016000088964

(51) Int. Cl. E05D 15/06; E05F 1/02

(52) U.S. Cl. CPC E05D 15/063; E05F 1/02; E05Y 2900/132; E05Y 2201/638; E05Y 2201/684; E05Y 2201/412

(57) ABSTRACT

The present invention concerns a slide device (200) for a sliding door (100), comprising a carriage (210), a slide seat (220) on at least part of which the carriage (210) can slide, and wherein the slide seat (220) comprises a transformation region (230) configured in such a way as to convert a potential energy into a force applied to the carriage (210), so as to cause the latter to slide.

### TECHNICAL FIELD OF THE INVENTION

The present invention concerns the field of door and/or window frames. Even more particularly, the present invention concerns a device suited to facilitate the use of sliding doors and/or similar elements, such as hidden partitions, sliding windows, etc.

Even more precisely, the invention concerns a slide device that facilitates the operation of sliding doors and/or similar elements during the last step of their opening and/or closing movement.

### STATE OF THE ART

Sliding doors or similar elements, such as hidden partitions or sliding windows that slide along a predetermined direction, are known in the state of the art. These elements are commonly used in combination with a hollow wall, in such a way as to allow the door to be hidden inside the cavity in the wall.

FIG. 1 schematically shows a side view of a sliding door 100. As can be observed, the sliding door 100 comprises a door 101, or more generally a panel, connected to a slide seat 120 through one or more carriages 110. In particular, the carriage 110 generally comprises at least one wheel 111 which can roll along the slide seat 120.

A problem posed by such a sliding door lies in that it is difficult to place the door in the completely open or completely closed position. In particular, assuming that the position shown in FIG. 1 is the completely open position, when the door 100 is moved in the direction indicated by the arrow towards the completely closed position, the user needs to accompany the door 100 and complete its movement, in such a way as to make sure that the door has reached said position. If this accompanying movement is not performed, the door 100 stops before reaching the completely closed position or reaches said position and then bounces back, stopping in a position which is away from the completely closed position.

In order to solve this problem, several systems have been conceived in the state of the art, which generally are used to retain the door and/or one or more of the carriages during the final step of the movement of the door itself. These systems, for example spring systems, are loaded at the moment when the door moves away from its terminal position, so that when the door approaches this position again they can retain the door and use the energy loaded inside them to bring the door to the completely open or completely closed position.

A drawback posed by the known devices lies in that the coupling and release mechanism of these devices is relatively noisy. Furthermore, these devices increase the cost of the door, as they must be manufactured, installed and set in addition to the slide seat 120, the door 101 and the carriages 110.

Thus, it is an object of the present invention to provide a device which makes it possible to guarantee the movement of the door until it reaches its extreme position, be it completely open or completely closed, or any other predetermined position, in a silent manner.

Further objects of the present invention include the object to limit the number of components necessary for making said device, the object to ensure that it behaves as reliably as possible over time, and the object to limit the cost resulting from the installation and setting of the device.

Devices for allowing a sliding movement of a door according to the prior art are known from documents EP 2 770 147 A2, WO 98/58150 A1, WO 2015/053627 A1, WO 2012/128494, FR 2 300 879 A1 and FR 3 021 685 A1.

### SUMMARY OF THE PRESENT INVENTION

The present invention is based on the general consideration according to which a certain amount of potential energy, for example of the gravitational and/or elastic type, can be used to guarantee the last part of the movement of the door by making this potential energy act on the sliding carriage of the door or storing it. In this way it is possible to reduce the number of components, since there is no need for another device in addition to the carriage.

Also the installation and setting of the sliding door are facilitated, as there is only the carriage to install, and not the carriage together with an additional device. Finally, since the carriage can be used in this manner, it is not necessary to install a device inside the cavity created in the wall, which in some cases may be a problem.

An embodiment of the present invention may concern a slide device for a sliding door, comprising: a carriage, a slide seat on at least part of which the carriage can slide, wherein the slide seat may comprise a transformation region configured to convert a potential energy into a force applied to the carriage, thus causing the latter to slide.

Thanks to this embodiment, it is possible to cause the movement of the carriage in the terminal portion of the slide seat without resorting to external elements that produce noise during the coupling with the carriage, increase production and installation costs and reduce reliability.

In some embodiments, the potential energy can be gravitational and/or elastic and/or magnetic energy.

Thanks to this embodiment, it is advantageously possible to use, and even to combine, different types of potential energy and thus different methods for storing the energy that will cause the carriage and therefore the door to move.

In some embodiments, the transformation region can have a slope different from zero with respect to the horizontal axis, in such a way as to convert a potential gravitational energy into a force applied to the carriage, and the carriage may comprise a first wheel configured so as to roll along the transformation region.

Thanks to this embodiment, it is advantageously possible to convert the potential gravitational energy of the door, or its weight force, into a lateral pushing force of the carriage with respect to the slide seat.

In some embodiments, the carriage may comprise a frame, the carriage may comprise a second wheel configured so that it rolls along the slide seat, and the first and the second wheel can be both connected to the frame in a fixed relative position with respect to each other.

Thanks to this embodiment, it is advantageously possible to obtain a lever system which makes it possible to control the ratio between the weight force of the door and the lateral pushing force acting on the carriage in a precise manner.

The device can thus be adapted to doors having different weights, without modifying the shape of the slide seat and of the transformation region.

Furthermore, this embodiment makes it advantageously possible to reduce the movement of the door in the vertical direction.

In some embodiments, the cross section of the transformation region can have a size different from that of the rest of the slide seat, in such a way as to convert a potential elastic energy into a force applied to the carriage, the carriage may comprise a third wheel and the carriage may comprise an elastic element and/or a rotation element configured so as to press the third wheel against the slide seat.

Thanks to this embodiment, it is advantageously possible to convert an elastic force into a lateral pushing force of the carriage.

In particular, in the case of an elastic force owing to which two elements are moved near each other, it will be possible to use a slide seat whose cross section is reduced in the transformation region.

On the contrary, in the case where the elastic force is such as to move the two elements away from each other, it will be possible to opt for a slide seat in several portions, configured so that the distance between two portions increases in the transformation region.

In some embodiments, the carriage may comprise a fourth wheel, and the elastic element and/or the rotation element can be configured so as to press the fourth wheel against the slide seat.

Thanks to this embodiment, it is advantageously possible to have the third and the fourth wheel act in such a way as to transform the potential elastic energy into a lateral moving force of the carriage, while the first and the second wheel can simply support the weight of the door and/or convert its potential gravitational energy into a lateral displacement force of the carriage.

It is thus possible to obtain great flexibility in the configuration of the device and in the choice of the type of potential energy to be used to move the carriage.

In some embodiments, the third and the fourth wheel can have their respective pins arranged in the vertical direction.

Thanks to this embodiment, it is advantageously possible to obtain a compact structure. Furthermore, in the case where the first and/or the second wheel is/are not present, it is also possible that the third and/or the fourth wheel support/supports the weight of the door.

In some embodiments, the rotation element may comprise a fixed portion and a rotatable portion, wherein the fixed portion may comprise a preferably helical sloped surface, the rotatable portion may comprise a bushing, and the rotation element may be configured in such a way that a force exerted along the rotation pin on the fixed portion causes a rotation of the rotatable portion due to the relative movement of the bushing with respect to the sloped surface.

Thanks to this embodiment, it is advantageously possible to convert a potential gravitational energy acting on the fixed portion into a rotation of the rotatable portion. As an alternative or in addition to the above, it is possible to convert a potential elastic energy acting between the fixed portion and the rotatable portion into a similar rotation.

### BRIEF DESCRIPTION OF THE FIGURES

Further characteristics and advantages of the invention will be highlighted in greater detail through the analysis of the following detailed description of some preferred but not exclusive embodiments, illustrated by way of indicative and not limiting example with the support of the attached drawings.

In the drawings, the same reference numbers identify the same components. In the figures:

FIG. 1 shows a schematic side view of a sliding door 100 according to the state of the art;

FIG. 2A shows a schematic side view of a sliding door and a corresponding slide device 200 according to an embodiment of the present invention;

FIG. 2B shows an enlarged schematic view of a part of FIG. 2A;

FIG. 2C shows a schematic view of a slide device 200C according to an alternative embodiment of the present invention;

FIG. 2D shows a schematic view of a slide device 200D according to an alternative embodiment of the present invention;

FIG. 2E shows a schematic view of a slide device 200E according to an alternative embodiment of the present invention;

FIGS. 3A and 3B show schematic side views of a slide device 300 according to an alternative embodiment of the present invention, in two different positions;

FIGS. 4A and 4B show schematic side views of a slide device 400 according to an alternative embodiment of the present invention, in two different positions;

FIGS. 5A and 5B show schematic side views of a slide device 500 according to an alternative embodiment of the present invention, in two different positions;

FIGS. 6A and 6B show schematic side views of a slide device 600 according to an alternative embodiment of the present invention, in two different positions;

FIG. 7A shows a schematic side view of a slide device 700A according to an alternative embodiment of the present invention;

FIG. 7B shows a schematic side view of a slide device 700B according to an alternative embodiment of the present invention;

FIG. 8A shows a schematic side view of a slide device 800A according to an alternative embodiment of the present invention;

FIG. 8B shows a schematic side view of a slide device 800B according to an alternative embodiment of the present invention;

FIG. 9A shows a schematic top view of a slide device 900 according to an alternative embodiment of the present invention;

FIG. 9B shows a schematic side view of the slide device 900 shown in FIG. 9A;

FIG. 9C shows a schematic sectional view of the slide device 900 shown in FIG. 9A;

FIG. 10 shows a schematic sectional view of a slide device 1000 according to an alternative embodiment of the present invention;

FIG. 11A shows a schematic exploded view of a carriage 1110 for a slide device 1100, according to alternative embodiments of the present invention;

FIG. 11B shows schematic side and top views of the carriage 1110 and/or of the slide device 1100 shown in FIG. 11A;

FIG. 11C shows the same schematic views of FIG. 11B in an operating position of the carriage 1110 and/or of the device.

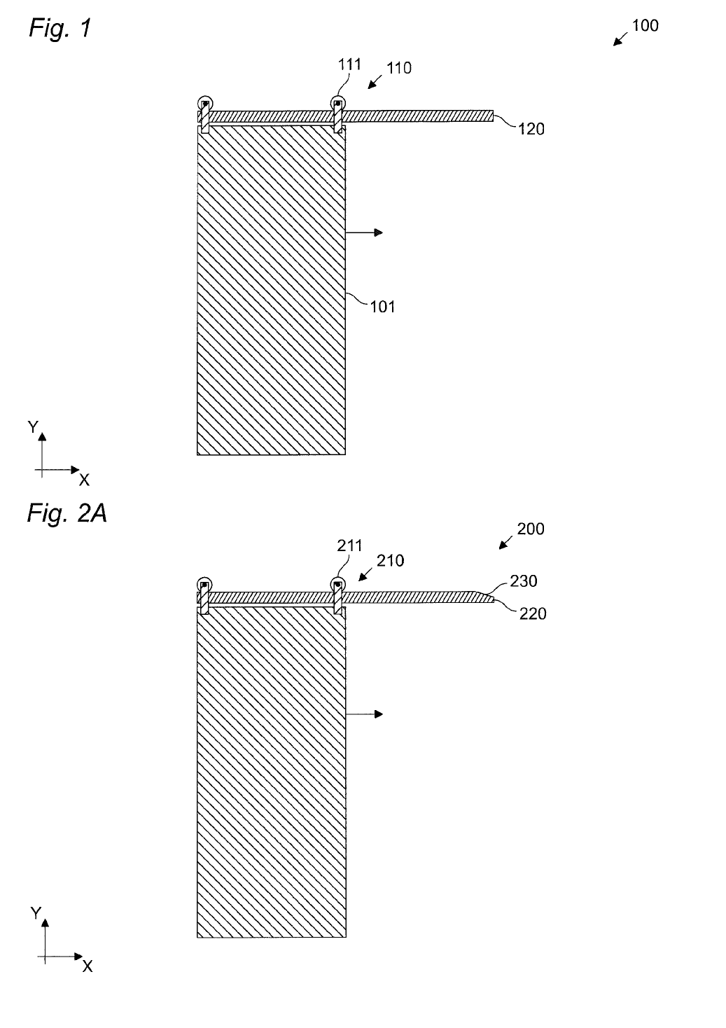

### DETAILED DESCRIPTION OF THE DRAWINGS

Here below is a detailed description of the embodiments of the present invention illustrated in the drawings. It should however be noted that the possible applications of the present invention are not limited to those illustrated and that the present invention is not limited to the embodiments represented in the drawings.

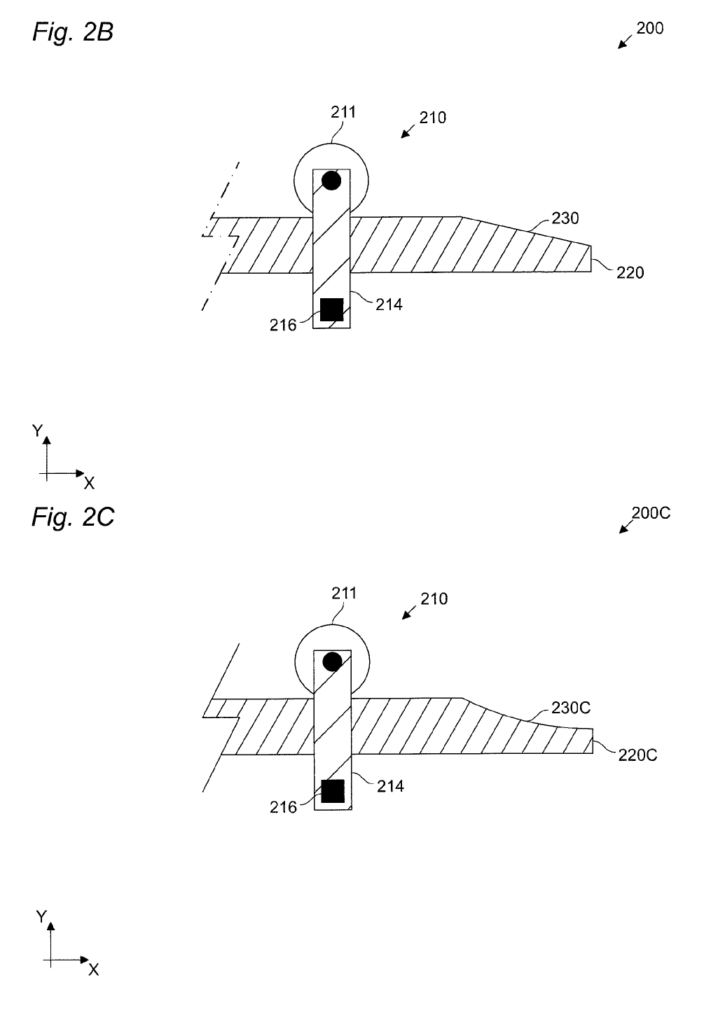

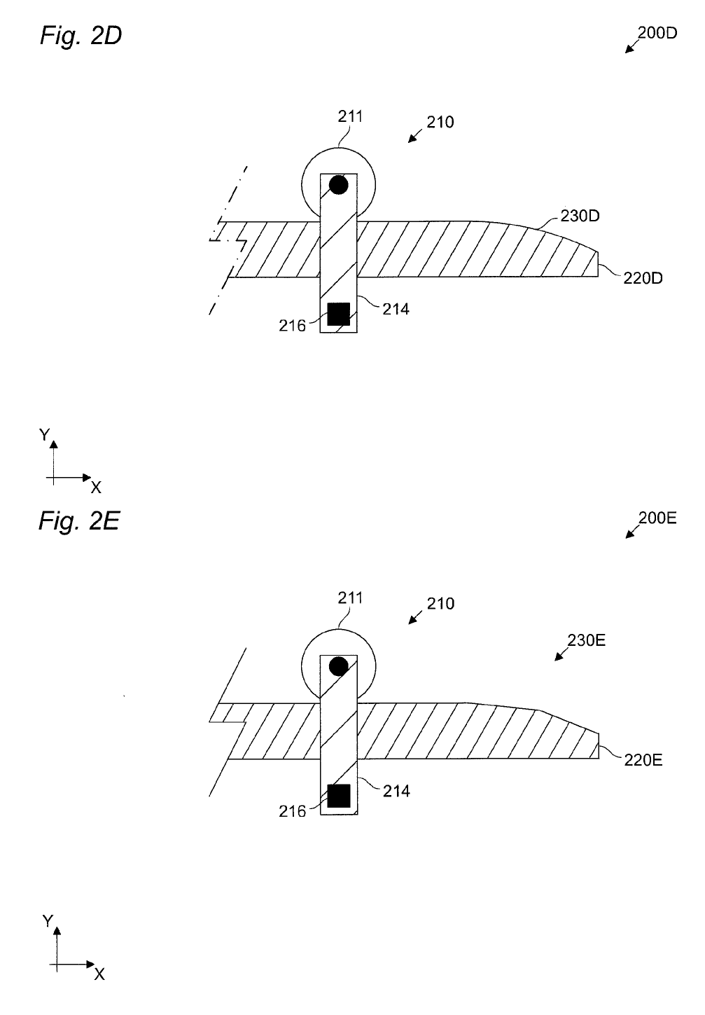

According to a first embodiment of the present invention, the slide device 200 illustrated in FIG. 2A differs from the slide device of the sliding door 100 in that the slide seat 220 according to the embodiment of the invention includes a transformation region 230. The purpose of the transformation region 230 is to transform a potential energy into a force applied to the carriage 210, in such a way as to cause the latter to slide along the slide seat 220.

With reference to FIG. 2B, which shows an enlarged view of the extreme right portion of the slide device 200, it is possible to observe how the transformation region 230, in this first embodiment, can be obtained through a slope different from zero with respect to the horizontal axis X.

More particularly, the slide device 200 comprises the slide seat 220 and one or more carriages 210.

At least one of the carriages 210 comprises a wheel 211 in such a way as to allow the sliding movement of the carriage 210 on the slide seat 220.

The wheel 211 is connected to the frame 214 of the carriage 210 by means of a pin and, if necessary, bearings which are not illustrated.

The frame 214 can be present on both sides of the slide seat 220 or on one of them only.

The wheel 211 and/or the slide seat 220 can be provided with grooves and/or corresponding projections in such a way as to ensure that the wheel 211 cannot move out of the slide seat 220.

The frame 214 of the carriage 210 furthermore comprises a support 216, only schematically illustrated herein, to which the door 101 can be connected.

Due to the effect of the weight of the door acting on the support 216, and thus on the frame 214 and finally on the wheel 211, when the carriage 210 reaches the transformation region 230, having a slope different from zero with respect to the horizontal axis X, it will tend to move downwards and thus towards the right.

In other words, the slope created by the transformation region 230 converts the potential gravitational energy of the door 101 into a force applied to the carriage in the positive direction X, so as to cause the latter to slide towards the right.

In this manner, it is possible to ensure that the door 101 comes to be positioned in the extreme right position.

If necessary, a stop element, a damper element, any other element suited to prevent the carriage 210 from moving out of the seat 220 can be provided in order to define precisely the end of stroke of the carriage 210.

Thanks to this embodiment, it is therefore possible to ensure that the door 101 comes to be positioned as far to the right as possible, thus facilitating the last step of its sliding movement thanks to the presence of the transformation region 230. Furthermore, since there are no elements that need to be coupled with the door, the operation of the door is particularly silent.

In addition to the above, since it is possible to obtain the transformation region 230 through a simple slope with respect to the horizontal axis, it is possible to make a particularly compact and economic slide device.

Finally, considering the limited number of moving parts and, more generally, the limited number of components of the slide device, its operation will be particularly reliable over time.

Even if in the embodiment shown in FIG. 2B the transformation region 230 has been illustrated as a substantially linear region having a constant slope with respect to the horizontal axis X, the present invention is not limited to this embodiment.

In particular, it will be possible to implement any shape of the slide seat 220 in the transformation region 230, provided that it allows a potential gravitational energy to be transformed into a force acting on the carriage 210.

By way of example, the slide devices 200C, 200D and 200E are respectively provided with slide seats 220C, 220D and 220E having respective transformation regions 230C, 230D and 230E in a concave curvilinear shape, a convex curvilinear shape and a multilinear shape.

It will be clear, however, that it is possible to implement any shape capable of exploiting the downward movement of the carriage 210, converting it into a movement towards the positive direction X.

The slide device 200 generally converts a downward movement of the door 101 into a movement of the carriage 210 in the positive direction X. In some cases, the downward movement of the door 101 may be undesired.

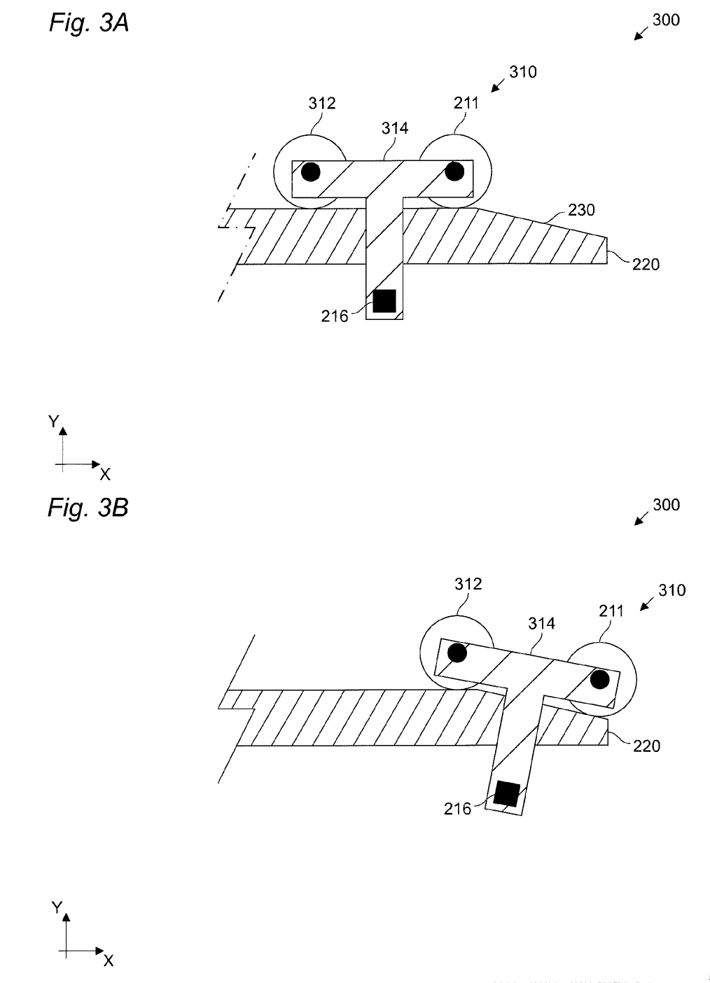

According to a further embodiment, the slide device 300 illustrated in FIGS. 3A and 3B advantageously reduces said downward movement.

In particular, the carriage 310 comprises a frame 314 provided with a first wheel 211 and a second wheel 312.

The frame 314 is substantially rigid, so that the first wheel 211 and the second wheel 312 are placed in a fixed relative position with respect to each other, while at the same time both of them are capable of rotating around their own pin.

By conveniently sizing the frame 314 with respect to the size of the transformation region 230, it is possible to make the wheel 211 move downwards along the transformation region 230, while the wheel 312 remains substantially out of the transformation region 230.

In this manner, the downward movement of the support 216 is reduced with respect to the previous embodiment.

Furthermore, the slide device 300 offers more flexibility in the selection of the force exerted on the carriage 310.

In particular, by conveniently selecting the position of the support 216 with respect to the pins of the wheels 211 and 312, it is possible to modify the lever ratio exerted by the weight of the door on the pin of the wheel 211 and thus modify the force with which the carriage 310 will be pushed in the positive direction X.

In some cases, the downward movement of the door cannot be accepted, even if in the slight extent produced by the slide device 300.

In these cases, a solution is offered by the slide device 400, which is carried out according to a further embodiment of the present invention.

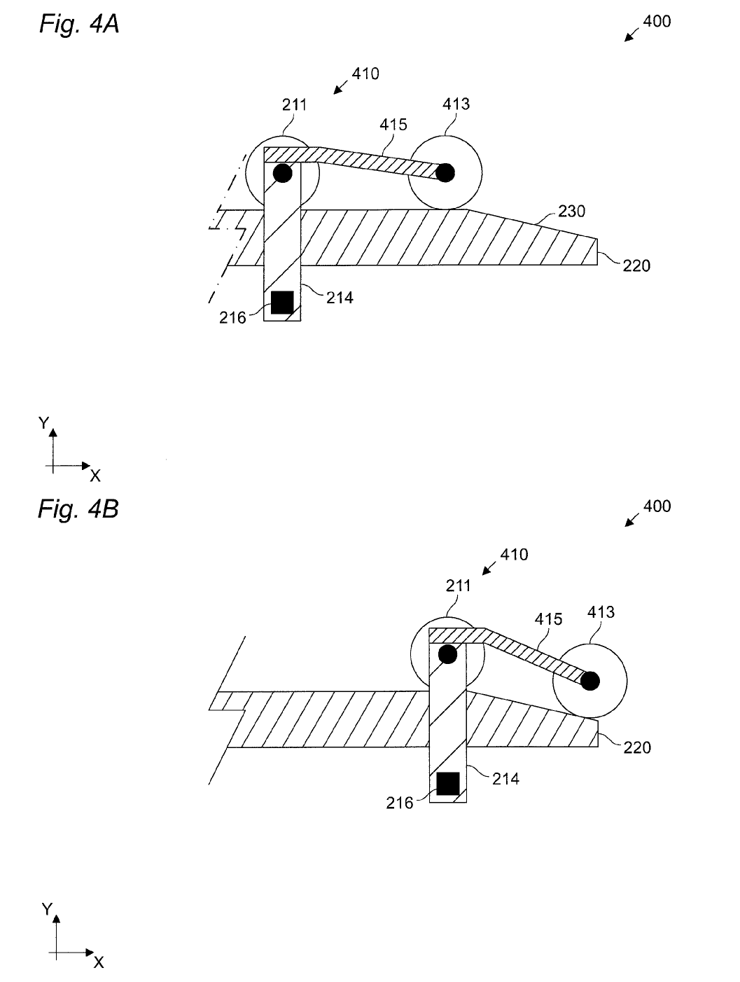

As can be seen in FIGS. 4A and 4B, the slide device 400 differs from the slide device 200 due to the presence of an elastic element 415.

In the case illustrated in the figure, the elastic element 415 is obtained by means of a leaf spring integrally connected to the frame 214 of the carriage 410.

However, it will be clear to the expert in the art that different types of springs and/or, more generally, different types of elastic elements 415 can be used in a similar manner in order to achieve the same purpose.

In particular, the elastic element 415 is configured in such a way that when it is in the rest position the wheel 413, connected at its end, is in a lower position than the wheel 211, with the frame 214 in a substantially vertical position as in the embodiment illustrated herein.

In other words, the elastic element 415 pushes the wheel 413 downwards.

This pushing action is ensured by the weight of the door which acts on the frame 214 so as to maintain the frame 214 in the substantially vertical position illustrated in FIGS. 4A and 4B.

At the moment when the wheel 413 comes to be positioned in the transformation region 230, the downward pushing action exerted by the elastic element 415 subjects the carriage 410 to a force in the positive direction X.

In this case, therefore, the potential energy which is transformed into a force moving the carriage 410 is not a potential gravitational energy, but a potential elastic energy contained within the elastic element 415.

The advantage offered by this implementation thus lies in that the door does not move in the vertical direction, as it happens instead with the slide devices 200 and 300.

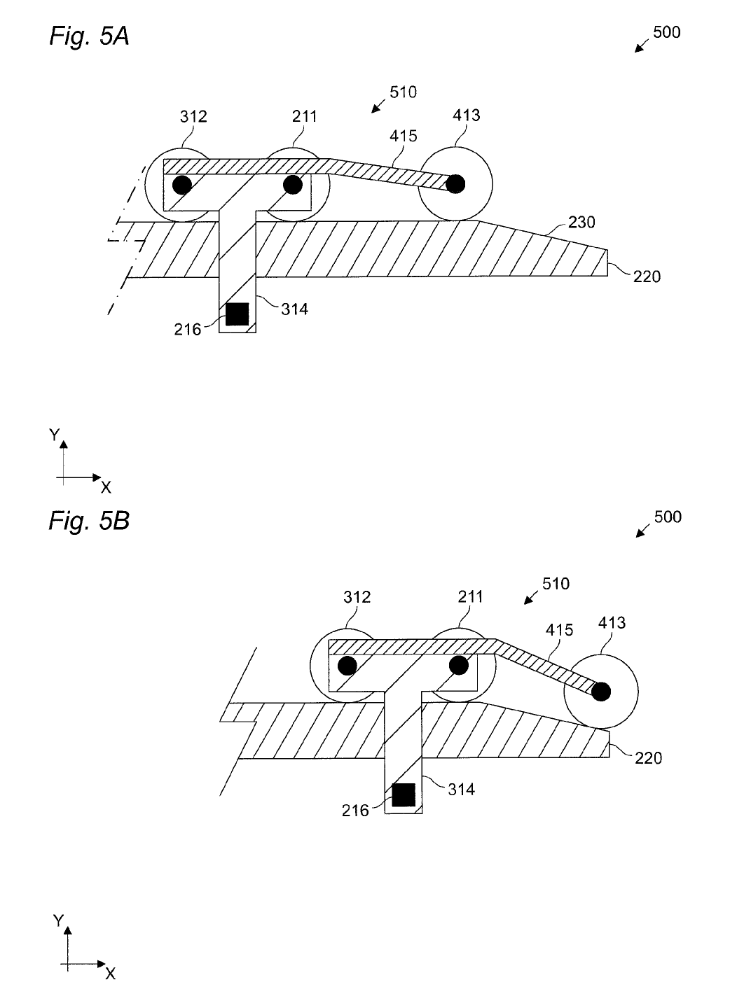

The slide device 500, illustrated in FIGS. 5A and 5B, represents an alternative embodiment of the slide device 400, in which the frame 314 is used instead of the frame 214.

In this manner, it is advantageously possible to prevent the frame 314 from oscillating with respect to the illustrated position under the elastic action of the elastic element 415.

In particular, the presence of the two wheels 211 and 312, with respect to the case of the single wheel 211 of the slide device 400, improves the stability of the frame 314 with respect to the slide seat 220.

Furthermore, by reducing the possibility of occurrence of such oscillations, it is possible to reduce the risk of the frame 314 being ejected out of the slide seat 220.

It will be clear that, even if in the embodiments illustrated with reference to the slide device 400 and 500 the only force acting on the respective carriages 410 and 510 is the force produced by the conversion of the potential elastic energy contained in the elastic element 415, the present invention is not limited to this case.

In hybrid embodiments, it will thus be possible to convert both the potential elastic energy contained in the elastic element 415 and the potential gravitational energy exerted by the door 101 into a rightward movement of the carriages 410 and 510.

In particular, this can be obtained by sizing the carriages and the slide seats 220 in such a way as to allow one or both of the wheels 211, 312 to interact with the transformation region 230.

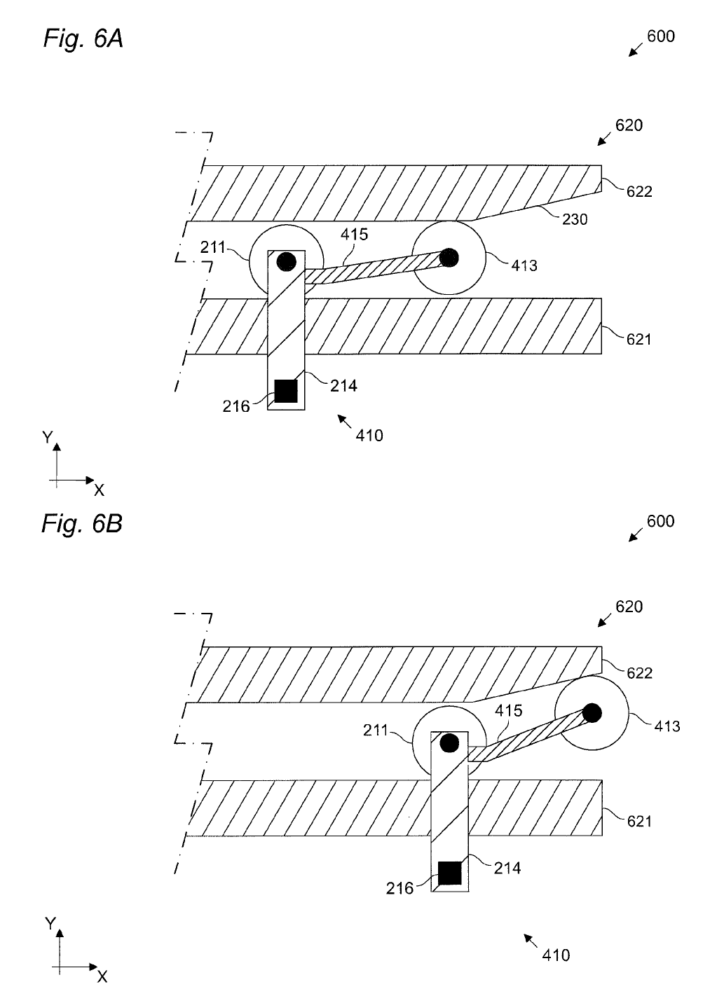

The operation of the slide device 600 illustrated in FIGS. 6A and 6B is substantially similar to the operation of the slide device 400, but differs from the latter in that the elastic element 415 presses the wheel 413 upwards instead of pressing it downwards on the slide seat 220. In this case, the slide seat 620 thus comprises two portions 621, 622. The wheel 211 moves on the portion 621 of the slide seat 620, while the wheel 413 moves on the portion 622 of the slide seat 620 under the action of the elastic element 415.

The presence of the transformation region 230 in the portion 622 of the slide seat 620 guarantees that the slide device 600 operates in a manner which is similar to that of the slide device 400.

Furthermore, the slide device 600, compared to the slide device 400, is particularly advantageous, as the combination of the wheel 211 pushed downwards by the weight of the door with the wheel 413 pushed upwards by the elastic element 415 advantageously give stability to the carriage 214, thus preventing it from jerking along the vertical axis.

This leads to the increased reliability of the slide device 600, which prevents the risk of the carriage 410 moving out of its slide seat.

Furthermore, the absence of jerks makes the operation of the slide device 600 more silent.

In addition to the above, by dividing the slide seat 620 in two portions 621, 622 it is possible to create two transformation regions 230.

In particular, while in the embodiment illustrated only the portion 622 comprises a transformation region 230 suited to convert the potential elastic energy contained inside the elastic element 415, it will also be possible to create a transformation region 230 in the portion 621, said transformation region 230 being suited to convert the potential gravitational energy of the door, as previously explained with reference to the slide device 200.

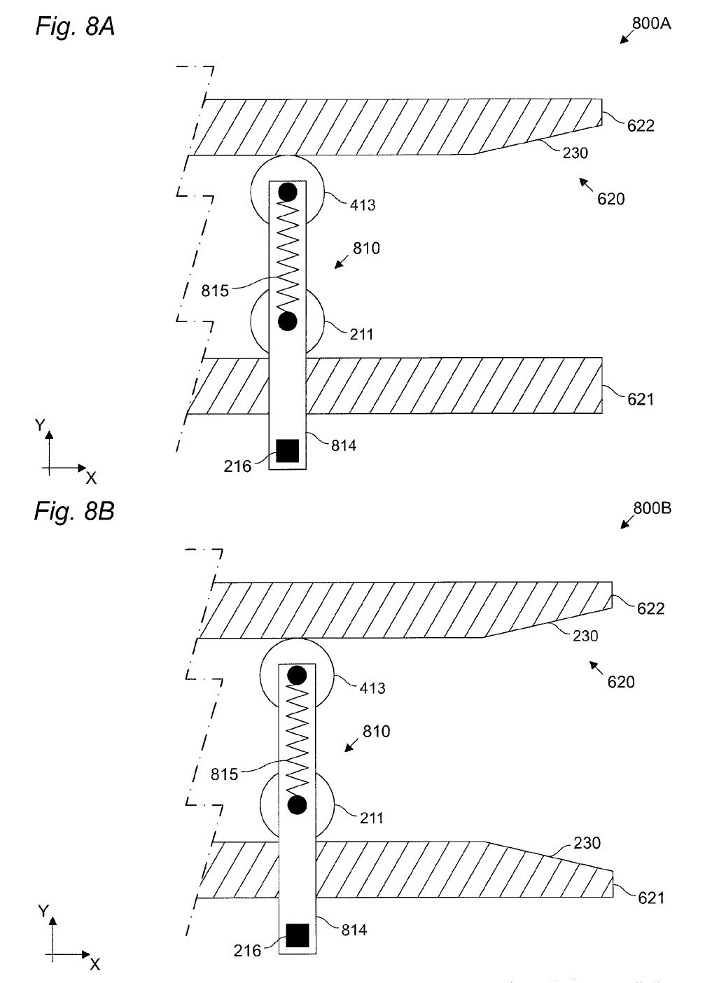

In other words, it will be possible to create a transformation region 230 only on the portion 621, only on the portion 622, or on both portions, as shown for example in FIG. 8B.

Even if the slide device 600 has been described as based on the frame 214, it will be clear that an analogous embodiment can be based on the frame 314.

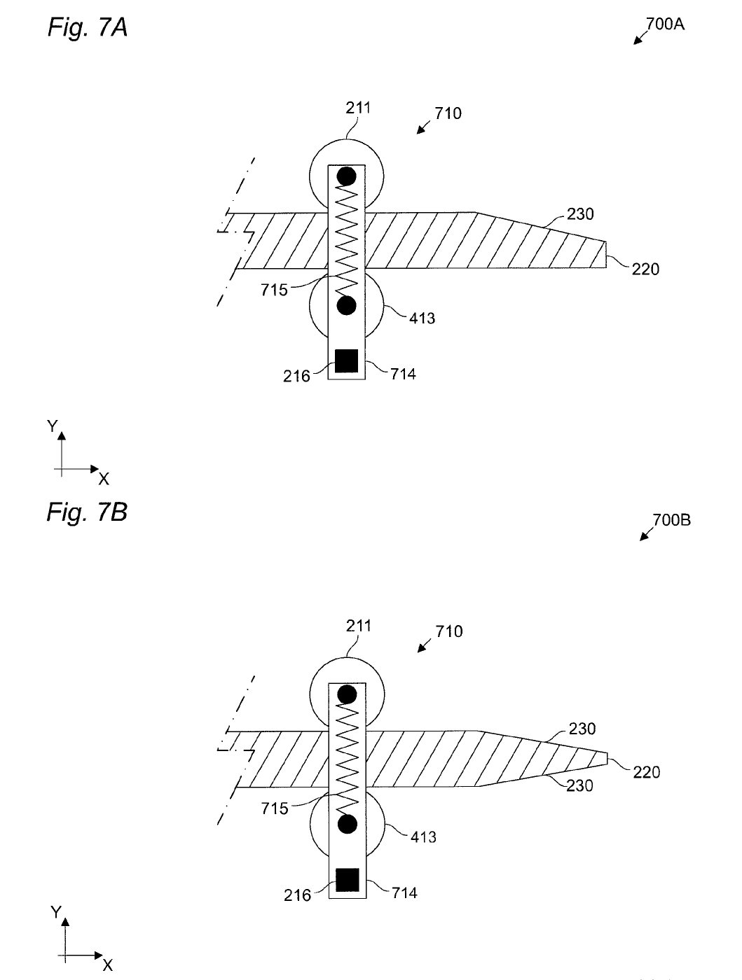

According to an alternative embodiment of the present invention, the slide device 700A illustrated in FIG. 7 makes it possible to convert a certain amount of potential elastic energy contained inside an elastic element 715 into a rightward movement of the carriage 710.

In particular, the elastic element 715 schematically illustrated in the figure as a spring connected to the two pins of the wheels 211 and 413 is configured in such a way as to press the wheels 211 and 413 respectively towards the slide seat 220. In the embodiment illustrated, this makes it possible to convert the potential elastic energy contained in the elastic element 715 into a force acting on the carriage 710 towards the positive direction X in addition to the force deriving from the conversion of the potential gravitational energy of the door, as the transformation region 230 is located on the side of the slide seat 220 on which the wheel 211 slides.

However, the present invention is not limited to this embodiment and the embodiment in which the slide seat 220 is in the opposite position can also be implemented.

In this embodiment, it will thus be possible to convert only the potential elastic energy contained in the elastic element 715 into a force acting on the carriage 710, advantageously maintaining the vertical position of the door in an unaltered manner.

In both of these embodiments, in addition to providing the potential elastic energy that causes, alone or with other factors, the movement of the carriage 710, the presence of the elastic element 715 guarantees that the wheel 211 cannot move out of its slide seat 220, thus increasing the reliability of the slide device 700A and reducing its noise.

Also in this case, even if the embodiment has been illustrated with one wheel 211 only, it will be clear that it is possible to carry out an analogous embodiment in which there is also the second wheel 312.

The slide device 700B illustrated in FIG. 7B differs from the device 700A due to the presence of two transformation regions 230, on two opposite sides of the slide seat 220.

This embodiment advantageously makes it possible to increase the force exerted on the carriage 710, as the elastic element 715 can operate with a larger stroke.

In general, one or more transformation regions 230 can be present on one or more sides of the slide seat 220, in all of the embodiments of the present invention.

The slide device 800A illustrated in FIG. 8A differs from the slide device 700A in that the elastic element 815 does not tend to move the pins of the wheels 211, 413 near each other but, on the contrary, it tends to move them away from each other.

The operation, however, is similar, and it will be clear to the expert in the art that the elastic action exerted by the elastic element 815 on the wheel 413 is converted into a rightward movement of the carriage 810 by the transformation region 230. As previously described, also this embodiment can be carried out with two wheels, 211 and 312.

In addition or as an alternative to the above, also in this embodiment one or both of the portions 621, 622 of the slide seat 620 may comprise a transformation region 230, as previously described with reference to the slide device 600.

In particular, as illustrated in FIG. 8B, the device 800B comprises a transformation region 230 both in the portion 621 and in the portion 622 of the slide seat 620.

In all of the embodiments previously described, the pins of the wheels 211, 312, 413 are placed in a substantially horizontal position.

However, the present invention is not limited to this configuration and all the embodiments can be carried out also with the pins of all or some of the wheels 211, 312, 413 arranged according to a substantially vertical direction.

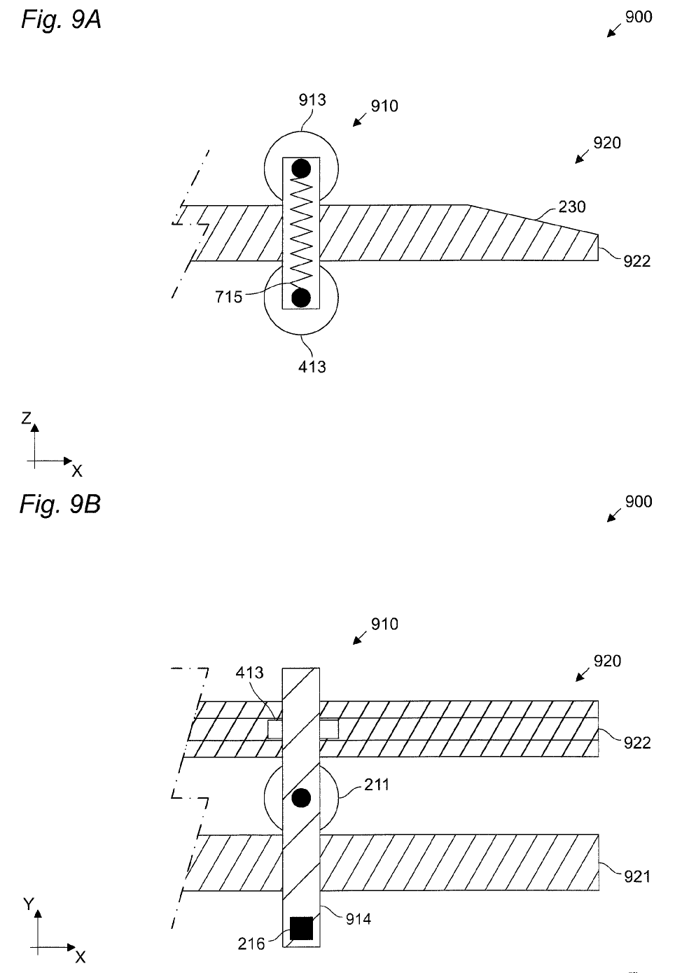

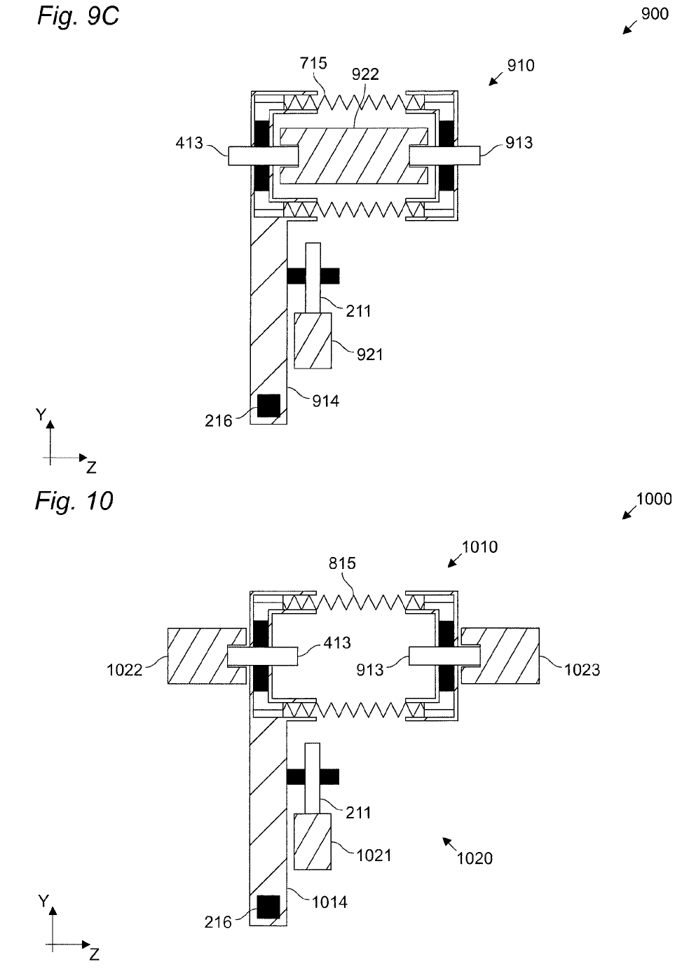

In particular, by way of example, a slide device 900 is described with reference to FIGS. 9A, 9B and 9C, wherein the weight of the door is supported by a wheel 211 having a substantially horizontal pin, while the force acting on the carriage 910 is obtained from the conversion of a potential elastic energy carried out by a transformation region 230 in combination with an elastic element 715 acting on two wheels 413, 913 having a substantially vertical pin.

More specifically, as can be seen in FIG. 9A, a first portion 922 of the slide seat 920 is provided with a transformation region 230 which interacts with the wheel 913 in such a way as to transform the potential elastic energy contained in the elastic element 715 in a manner analogous to that already described with reference to the slide device 700A.

However, as illustrated in the figures, it is possible to position the wheels 413 and 913 in a substantially horizontal direction.

Even if the sectional view of FIG. 9C shows the presence of grooves inside the portion 922 of the slide seat 920, it will be clear that the invention is not limited to this specific embodiment. In particular, the grooves make it advantageously possible to ensure that the wheels 413, 913 do not move out of the slide seat 922. However, an analogous effect can be obtained also if the grooves are not provided, for example by ensuring that sufficient elastic force is exerted by the leastic element 715.

In alternative embodiments, the presence of the grooves in the portion 922 of the slide seat 1020 furthermore allows the elimination of the wheel 211 and of the portion 921 of the slide seat 920.

In other words, the weight of the door is supported by the interaction of the wheels 413, 913 with the grooves provided in the portion 922 of the slide seat 920.

The slide seat 1000 illustrated in FIG. 10 shows a variant of the slide seat 900, in which there is no elastic element 715 acting in such a way as to move the wheels 413, 913 near each other and instead there is the elastic element 815 acting in such a way as to move the wheels 413, 913 away from each other, towards the respective portions 1022 and 1023 of the slide seat 1020.

The same observations already made with reference to the slide device 900 apply also to the slide device 1000, in particular with reference to the presence of the wheel 211 and of the portion 1021 of the slide seat 1020.

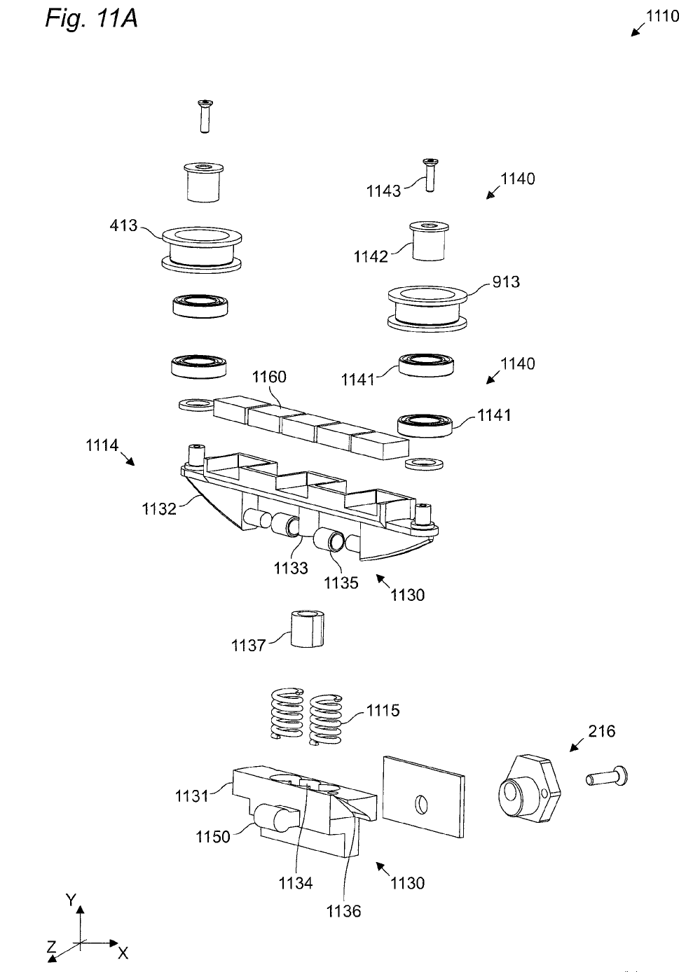

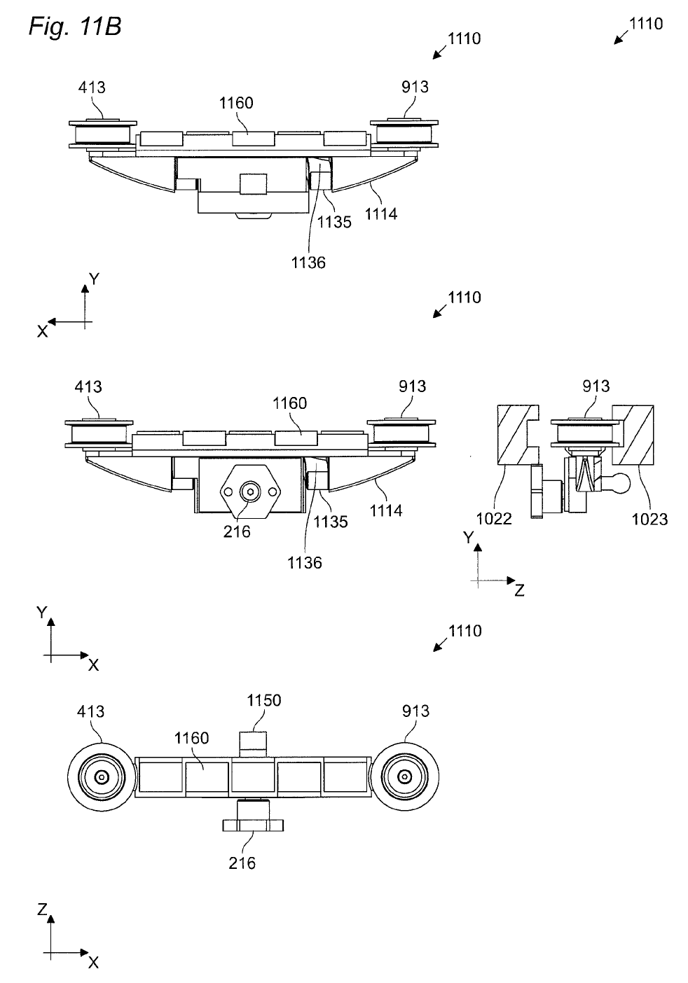

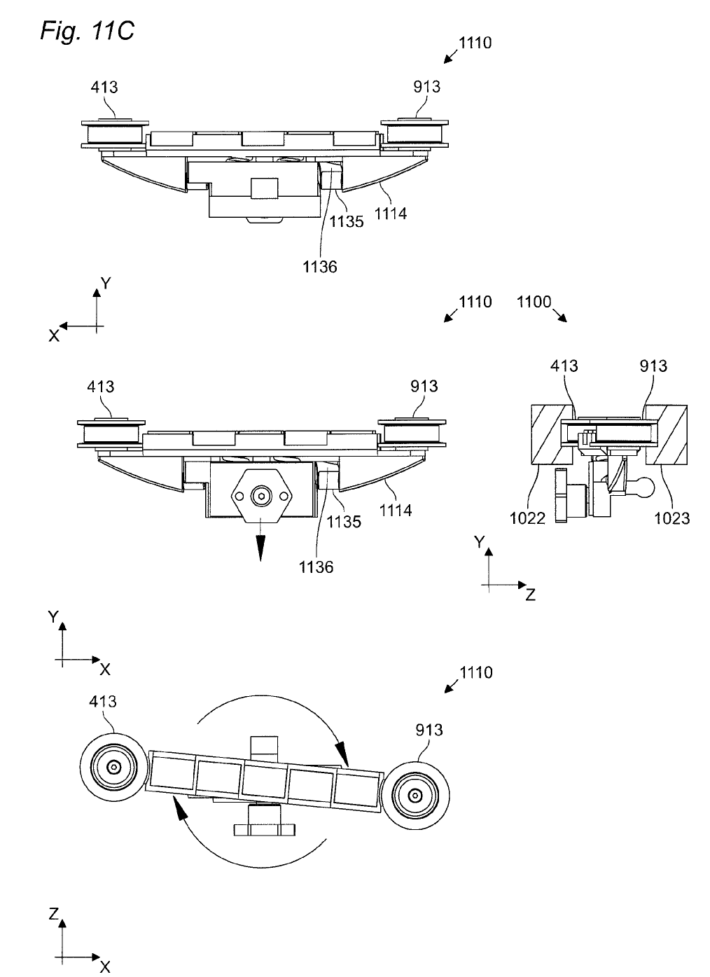

FIG. 11A shows a schematic exploded view of a carriage 1110 for a slide device 1100, according to alternative embodiments of the present invention.

FIG. 11B shows schematic side and top views of the carriage 1110 and/or of the slide device 1100 of FIG. 11A, while FIG. 11C shows the same schematic views of FIG. 11B in an operating position of the carriage 1110 and/or of the device 1100.

Generally, the slide device 1100 is provided with two wheels 413 and 913 sliding in two respective slide seats 1022 and 1023, similarly to what happens in the slide device 1000.

However, while in the slide device 1000 the wheels 413, 913 are pushed towards the respective seats 1022, 1023 by the action of the elastic element 815, in the carriage 1110 and in the corresponding slide device 1100 the pushing action of the wheels 413 and 913 is exerted by the combination of the action of an elastic element 1115 with the action of the door's weight.

In an alternative embodiment, the elastic element 1115 can even be eliminated, in such a way as to make the device operate only with the potential gravitational energy exerted by the door.

More specifically, as can be seen in FIG. 11A, the carriage 1110 comprises a frame 1114 on which the wheels 413 and 913 are installed.

In the specific embodiment illustrated herein, each one of the wheels interacts with the frame 1114 through one or more bearings 1141, a bushing 1142 and a screw 1143.

It will be clear that this specific embodiment is just one possible example of how the two wheels 413, 913 can be connected to the frame 1114.

More generally, it is possible to implement any embodiment allowing the wheels 413, 913 to be connected to the frame 1114 so that the wheels 413, 913 have a substantially vertical pin.

The frame 1114 furthermore comprises a fixed portion 1131 and a rotatable portion 1132. The combination of the fixed portion 1131 with the rotatable portion 1132 produces a rotation element 1130 which, as described below, converts the weight of the door, acting on the fixed portion 1131, into a rotation of the rotatable portion 1132 with respect to the fixed portion 1131.

More particularly, the rotatable portion 1132 comprises a rotation pin 1133 which, if necessary through an optional bushing 1137, comes to be positioned inside a respective hole 1134 made in the fixed portion 1131.

It will be clear that the inverse solution, in which the rotation pin 1133 belongs to the fixed portion 1131, can also be implemented.

In this manner, the fixed portion 1131 and the rotatable portion 1132 can rotate with respect to each other with the axis 1133 serving as rotation.

The fixed portion 1131 furthermore comprises at least one sloped surface 1136 having a preferably helical shape.

In the embodiment specifically illustrated herein, there are two such surfaces 1136, only one of which is visible in FIG. 11A, since the symmetrical surface is located behind the fixed portion 1131.

At the same time, the rotatable portion 1132 comprises at least one bushing 1135, or more generally an element that can move along the sloped surface 1136. It will be clear that the bushing 1135, or a bearing, allows such a movement to be performed with reduced friction.

However, such an embodiment is not necessary and it will be possible to carry out the invention also replacing the bushing 1135 with a fixed pin with respect to the rotatable portion 1132.

When the fixed portion and the rotatable portion are assembled together, the bushing 1135 comes to be positioned under the sloped surface 1136.

At the moment when the fixed portion 1131 is pushed downwards, the inclination of the sloped surface 1136 and its interaction with the bushing 1135 thus produces a rotation of the rotatable portion 1132 with respect to the fixed portion 1136. Such downward movement of the fixed portion 1131 is guaranteed by the weight of the door sustained by the support 216 which is connected to the fixed portion 1131.

In the embodiment illustrated herein there are also two elastic elements 1115 in the form of two springs, which contribute to guaranteeing that the fixed portion 1131 tends to move away from the rotatable portion 1132.

However, as previously indicated, said elastic elements 1115 are optional.

As can be better understood with reference to FIGS. 11B and 11C, at the moment when the fixed portion 1131 is fastened to the door, its movement with respect to the axis X becomes impossible.

The weight force of the door acting on the fixed portion 1131 thus tends to make the rotatable portion 1132 rotate in the direction indicated by the arrow in the top view of FIG. 11C. This rotation guarantees that the wheel 413 is pushed towards the slide seat 1022 while the wheel 913 is pushed towards the slide seat 1023.

In this manner, by advantageously exploiting the weight of the door it is possible to ensure that the two wheels are pushed towards their respective slide seats and maintain the carriage in its position with respect to the slide seat 1020.

Analogously to what has been described above with reference to the preceding embodiments, at the moment when a transformation region 230, in the form of an area in which the inner distance between the slide seats 1022 and 1023 increases, for example in a manner analogous to that which has been illustrated with reference to the slide seats 621 and 622, it will be possible to convert the potential gravitational energy of the door into a lateral force acting on the carriage 1110 due to the interaction between the rotation force of the rotatable portion 1132 and the slide seat 1020.

In other words, at the moment when the distance between the slide seats 1022 and 1023 increases, the carriage 1110 will tend to move in the direction according to which the distance between the slide seats 1022 and 1023 increases, thus transforming the potential gravitational energy of the door into a movement force of the carriage 1110, analogously to that which happens in the embodiments previously described.

The optional presence of the elastic elements 1115 is advantageous as it makes it possible to increase the rotational force transmitted to the rotatable portion 1132. Furthermore, in some embodiments, the carriage 1110 comprises a stop element 1150 that can be used to stop the carriage, and thus the door, once they have reached their extreme position. In order to prevent the door from hitting, for example, against the frame, the stop element 1150 often cooperates with a damper element (not illustrated) mounted on the slide seat, or on the door frame, or more generally on the wall or the bearing structure of the door.

When the stop element 1150 comes into contact with the damper element, it will be possible to compress the latter only by exerting a certain force, for example equal to 200-300 grams. The elastic elements 1115 can advantageously be selected, in consideration of the geometry of the rotation element 1130, in such a way as to compensate for such a force.

It will be clear that the force exerted by the stop element 1150 in the sliding direction of the door depends not only on the force exerted by the elastic element 1115, but also on the conversion carried out by the rotation element 1130. Said conversion value, or lever value, will thus be advantageously taken in consideration when it comes to selecting the value of the elastic constant of the elastic element 1115.

In particular, at the moment when the rotation force exerted by the elastic elements 1115 substantially compensates for the force necessary for the compression of said damper element, it is advantageously possible to obtain a movement which is substantially similar for doors with different weights.

This is due to the fact that the pushing force acting on the door will be substantially proportional to the weight of the door, as the force exerted by the elastic elements 1115 is compensated for by the damper element.

Since also the inertia of the door with respect to motion is substantially proportional to the weight of the door, the result is that the acceleration of the door in the final part of its movement, or more generally the speed of movement of the door, will be substantially constant, independently of the weight of the door.

In this manner, in the presence of the damper element, the elastic elements 1115 make the operation of the system independent of the weight of the door, thus creating a self-adjusting mechanism.

In the embodiment illustrated in FIGS. 11A, 11B and 11C, the carriage 1110 furthermore comprises one or more magnetic elements 1160, for example in the form of permanent magnets.

The advantage offered by the magnetic elements 1160 lies in that they are attracted towards the slide seats 1022 and/or 1023 and/or towards a metallic element positioned over the slide seats 1022, 1023.

In this manner, it is possible that the magnetic elements 1160, integrally connected to the frame 1014, have an attraction force in the positive direction Y, in such a way as to support part of the weight of the door, thus making the sliding movement of the wheels 413, 913 inside their respective seats easier.

Obviously, even if the present invention has been illustrated by means of the preceding detailed description of the embodiments represented in the drawings, the present invention is not limited to the embodiments represented in the drawings and described in detail above.

In particular, it will be clear that different elements of different embodiments can be independently combined with one another.

The scope of the present invention is then defined in the claims.

1.-4. (canceled)

5. A slide device for a sliding door, comprising:
a carriage comprising at least a first wheel;
a slide seat on at least part of which the first wheel of the carriage can slide,
wherein the slide seat comprises a transformation region configured so as to convert a potential energy into a force applied to the carriage, so as to cause the latter to slide,
wherein the cross section of the transformation region has a size which is different from that of the rest of the slide seat, so as to convert a potential elastic energy into a force applied to the carriage,
wherein the carriage comprises a second wheel, and
wherein the carriage comprises an elastic element and/or a rotation element configured so as to press the second wheel against the slide seat,
characterized in that the first wheel and the second wheel have parallel rotation axis with respect to each other.

6. A device according to claim 5, wherein the carriage comprises a third wheel, wherein the elastic element and/or the rotation element is/are configured so as to press the third wheel against the slide seat.

7. A device according to claim 6, wherein the second wheel and the third wheel have their respective pins arranged according to a vertical direction (Y).

8. A device according to claim 5, wherein the rotation element comprises a fixed portion and a rotatable portion, wherein the fixed portion comprises a preferably helical sloped surface, wherein the rotatable portion comprises a bushing, and wherein the rotation element is configured so that a force exerted along the rotation pin on the fixed portion causes a rotation of the rotatable portion due to the effect of the relative movement of the bushing with respect to the sloped surface
